(19) United States
(12) Patent Application Publication
(10) Pub. No.: US 2016/0266343 A1
(43) Pub. Date: Sep. 15, 2016

(54) Optical-Fiber Ribbon With Reduced-Diameter Optical Fibers

(71) Applicant: OFS Fitel, LLC, Norcross, GA (US)

(72) Inventors: Peter A Weimann, Atlanta, GA (US); Heng Ly, Stone Mountain, GA (US)

(21) Appl. No.: 14/641,464

(22) Filed: Mar. 9, 2015

(51) Int. Cl. G02B 6/44

(52) U.S. Cl. CPC G02B 6/4403; G02B 6/443

(57) ABSTRACT

An optical-fiber ribbon with reduced-diameter optical fibers is disclosed in which the optical-fiber ribbon comprises a plurality of reduced-diameter optical fibers that meet the ITU-T G.657.A1 standard or the ITU-T G.652.D standard, and a ribbon matrix surrounding the reduced-diameter optical fibers, wherein a local matrix thickness of the optical-fiber ribbon is more than about 35 microns.

### BACKGROUND

1. Field of the Disclosure

The present disclosure relates generally to optics and, more particularly, to optical-fiber ribbons.

2. Description of Related Art

In building fiber-optic networks, cost reduction is always an issue. Generally speaking, larger cables are more difficult to handle, require larger installation space on aerial poles or in underground conduits, and cost more to install than smaller cables. For a given fiber count, optical fibers inside a smaller cable are less protected and thus more susceptible to signal attenuation due to microbends. Therefore, smaller cables tend to require premium optical fibers that are highly bend-insensitive. Such premium optical fibers have highly complex refractive index profile designs that are difficult and expensive to make. Therefore, it is desirable to have cost effective, yet durable compact cables that can maintain similar performance as comparable larger cables.

### SUMMARY

The present disclosure provides optical-fiber ribbons with reduced-diameter optical fibers. By using the optical-fiber ribbons, compact cables that maintain similar performance as equivalent larger cables can be made. Alternatively, for the same size cable, more optical fibers can be placed within the cable. For some embodiments, an optical-fiber ribbon comprises a plurality of reduced-diameter optical fibers, each of which is protected by certain thickness of a ribbon matrix. Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a graph comparing ribbon attenuations of typical optical-fiber ribbons using standard-sized optical fibers and reduced-diameter optical fibers.

FIG. 2 is a diagram showing one embodiment of the disclosed optical-fiber ribbon.

FIG. 3 is a graph showing ribbon attenuation of the optical-fiber ribbon shown in FIG. 2.

### DETAILED DESCRIPTION OF THE EMBODIMENTS

Fiber-optic networks are playing a larger role in data communications as customer demand for data capacity increases. In building fiber-optic networks, cost reduction is always an issue. Generally speaking, larger cables are more difficult to handle, require larger installation space on aerial poles or in underground conduits, and cost more to install than smaller cables.

In order to reduce the costs of the cable installation, others have used reduced-diameter optical fibers inside the cable. Traditional standard-sized single-mode optical fibers are approximately 250 microns in diameter, consisting of glass of about 125 microns diameter surrounded by protective coatings that have a total thickness of about 62.5 microns. However, reduced-diameter single-mode optical fibers are approximately 200 microns in diameter, consisting of glass of about 125 microns diameter surrounded by protective coatings that have a total thickness of about 37.5 microns. The difference in overall fiber size contributes to the reduction of the cable size.

However, because of the reduction in the thickness of protective coatings, the reduced-diameter optical fibers inside a smaller cable are more susceptible to microbends which can cause attenuation of the optical signal. In order to address the microbend issue, others used premium optical fibers that are highly bend-insensitive such as optical fibers that meet the ITU-T G.657.A2 standard. However, such premium optical fibers generally have highly complex refractive index profile designs that are difficult and expensive to make. Therefore, although the optical-fiber cables using such premium fibers are small and maintain similar performance as comparable larger cables, the cost of making the smaller cable would diminish or outweigh the cost reduction in the cable installation. Therefore, it is desirable to have cost effective, yet durable compact cables that can maintain similar performance as comparable larger cables while using less expensive, more bend-sensitive optical fiber.

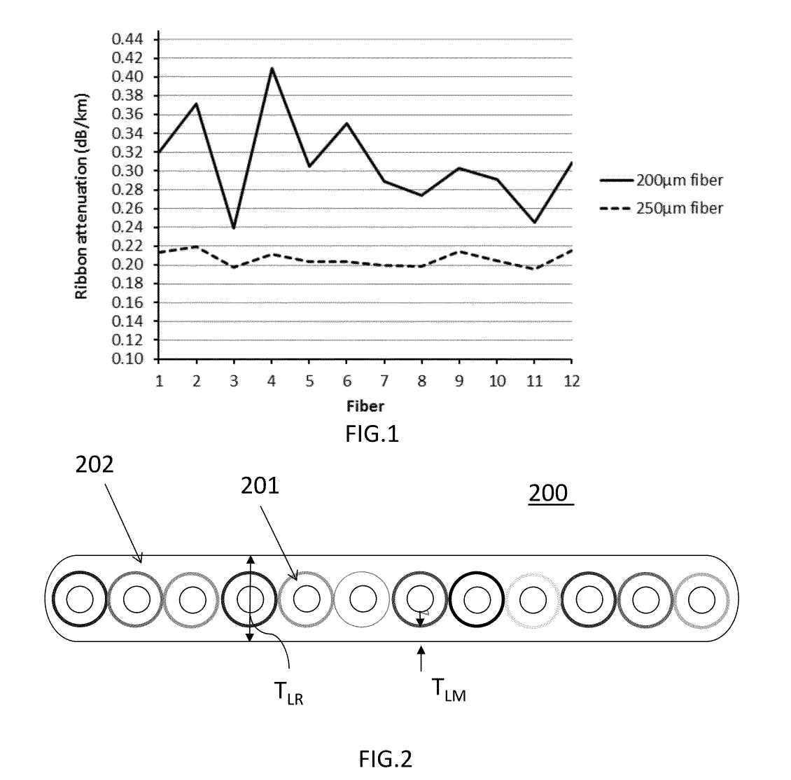

Optical-fiber ribbons are often used to put more optical fibers inside a cable in a given cross sectional area. An optical-fiber ribbon is an array of optical fibers, usually between 2 to 36 fibers, packed in parallel and optical fibers are held together by an adhesive matrix material. Typically, the amount of matrix needed to adhere standard-sized optical fibers in a ribbon is about 15 to 30 microns thick for the ribbon to have good handling and satisfactory optical performance. However, when a ribbon using reduced-diameter optical fibers is made with the same matrix thickness, the ribbon can exhibit unacceptably high ribbon attenuation. FIG. 1 shows a graph comparing ribbon attenuations of two typical optical-fiber ribbons, one using standard-sized (250 micron) ITU-T G.652.D optical fibers, and one using reduced-diameter (200 micron) ITU-T G.657.A1 optical fibers. In FIG. 1, both ribbons have the same matrix thickness, yet the ribbon with reduced-diameter optical fibers suffered much higher attenuation. The reduced-diameter optical fibers used in this example are approximately 200 microns in diameter, and compatible with the ITU-T G.657.A1 standard and/or the ITU-T G.657.D standard. These fibers are more bend sensitive than optical fibers with approximately 200 micron diameter that meet the ITU-T G.657.A2 standard. However, G.657.A1 or G.652.D fibers have less complicated refractive index profile designs that are easier and cheaper to make than optical fibers that meet the ITU-T G.657.A2 standard. Although it is desirable to reduce the cable size, the reduced-sized cable must maintain similar performance of an equivalent larger cable and yet be cost effective to be widely adapted in the industry.

The various embodiments address these and other shortcomings associated with conventional optical-fiber cables having optical-fiber ribbons with reduced-diameter optical fibers by providing more protection through a ribbon matrix layer. Because each of the reduced-diameter optical fibers is protected by a sufficient amount of ribbon matrix, ribbon attenuation of the optical-fiber ribbons with reduced-diameter optical fibers is comparable with that of optical-fiber ribbons with standard-sized optical fibers. Furthermore, because the reduced-diameter optical fibers are cost effective G.657.A1 and/or G.657.D fibers, the optical-fiber ribbons (and optical fiber cables using such ribbons) are cost effective. In other words, the disclosed embodiments will enable reduce-sized cables that maintain similar performance of an equivalent larger cable and yet are cost effective to be widely adapted in the industry.

Having provided a general description of one embodiment of an optical-fiber ribbon with reduced-diameter optical fibers, reference is now made in detail to the description of the embodiments as illustrated in the drawings. While several embodiments are described in connection with these drawings, there is no intent to limit the disclosure to the embodiment or embodiments disclosed herein. On the contrary, the intent is to cover all alternatives, modifications, and equivalents.

FIG. 2 is a diagram showing one embodiment of the disclosed optical-fiber ribbon 200. In particular, FIG. 2 shows a cross-section of a 12-fiber optical-fiber ribbon 200 with reduced-diameter optical fibers 201. As shown in FIG. 2, the optical-fiber ribbon 200 comprises a plurality of reduced-diameter optical fibers 201 and a ribbon matrix 202 surrounding the reduced-diameter optical fibers 201.

Each of the reduced-diameter optical fibers 201 meets the ITU-T G.657.A1 standard or the ITU-T G.652.D standard. The ITU-T G.657.A1 standard is referring to the ITU-T G.657.A1 (October 2012) recommendations specified by Telecommunication Standardization Sector of the International Telecommunication Union. Similarly, the ITU-T G.652.D standard is referring to the ITU-T G.652.D (October 2012) recommendations specified by the same entity. In addition, the reduced-diameter optical fibers 201 shown in FIG. 2 are single-mode optical fibers.

Furthermore, each of the reduced-diameter optical fibers 201 is coated with primary and secondary coatings, and has an outer diameter of less than about 205 microns. Although not shown in FIG. 2, each reduced-diameter optical fiber 201 has a glass fiber at the center, a primary coating surrounding the glass fiber, and a secondary coating surrounding the primary coating. Traditional standard-sized single-mode fibers are approximately 250 microns in diameter, about 125 microns of which is made of glass and the rest is made of protective coatings that have a total thickness of about 62.5 microns. However, reduced-diameter single-mode optical fibers are approximately 200 microns in diameter, about 125 microns of which is made of glass and the rest is made of protective coatings that have a total thickness of about 37.5 microns.

Preferably, the reduced-diameter optical fibers are colored for identification. For example, the secondary coating may be colored during a fiber draw (an in-line coloring process), or after the colorless optical fiber is drawn, a tertiary color coating may be applied to the optical fiber (an off-line coloring process).

Furthermore, the reduced-diameter optical fibers preferably have a slickness of less than about 10 g, and an outer most coating of the reduced-diameter optical fibers is substantially cured for easy stripping of ribbon matrix. The slickness is a measure of a fiber's surface friction when it slides against itself. The slickness is measured through the following slickness test. First, a fiber is taken and tied using double knots into a loop that has a diameter of 5 inches. Then, both free ends of the fiber are attached to a force measuring machine, such as an Instron tensile testing machine. One end of fiber is moved up by the crosshead of the machine at approximately 10 mm/minute, while the other end stays fixed. As one end moves up, the loop gets smaller, forcing the fiber to rub against its own surface. The peak force measured during this pulling is measured. In this specification, “substantially cured” means that at least 87% of the coating is cured. The RAU (Residual Acrylate Unreacted) method can be used to determine percentage of cured coating. By using a FTIR spectrometer or a similar machine, one skilled in the art can measure the percentage of unreacted acrylate. From the information, one can determine how much acrylate has been cured.

The optical-fiber ribbon 200 has a local matrix thickness T_{LM} of more than about 35 microns. Preferably, the local matrix thickness is more than about 40 microns. In this specification, “local matrix thickness” is defined as a minimum distance between an outer surface of the reduced-diameter optical fiber and an outer surface of the optical-fiber ribbon as indicated in FIG. 2 as T_{LM}.

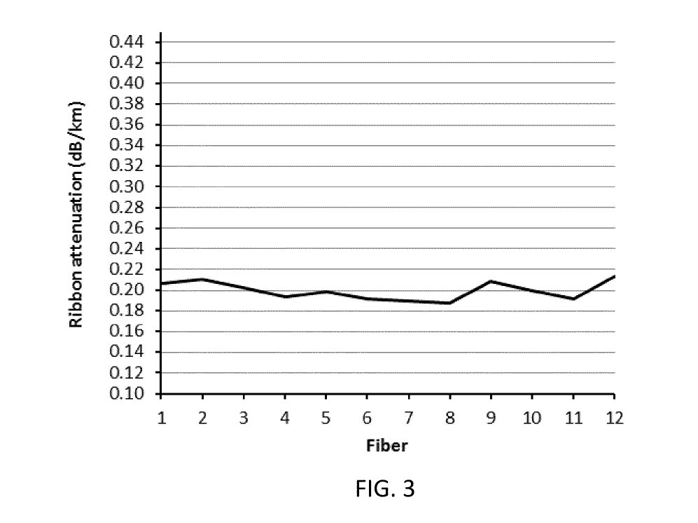

The optical-fiber ribbon 200 exhibits ribbon attenuation of less than about 0.35 dB/km at a wavelength of 1310 nanometers, and less than about 0.25 dB/km at a wavelength of 1550 nanometers. The ribbon attenuation is measured in accordance with the FOTP-78 standard in which the optical-fiber ribbon was measured on a ribbon spool having a hub diameter of 5.54 inches using an optical time-domain reflectometer (OTDR). FIG. 3 shows ribbon attenuations measured on the optical-fiber ribbon 200 using the measurement method described above at a wavelength of 1550 nanometers.

In FIG. 3, the ribbon attenuation of 12-fiber ribbon with reduced-diameter optical fibers is measured. The optical-fiber ribbon 200 used in FIG. 3 measurement has 200 micron optical fibers that are surrounded by a ribbon matrix having local matrix thickness of at least 35 microns. The 200 micron fibers used in this example are compatible with the ITU-T. G.657.A1 standard and/or the ITU-T G.657.D standard.

Referring back to FIG. 2, the ribbon matrix 202 is an UV-curable acrylate based resin. The main components of the ribbon matrix 202 are urethane acrylate oligomer, reactive monomer, release agent, and photo-initiator. Preferably, the ribbon matrix 202 has a tensile modulus of between 250 MPa and 800 MPa. The tensile modulus is measured at 2.5% strain. Furthermore, the ribbon matrix 202 preferably has a viscosity of between 3000 mPas-sec and 5000 mPas-sec at about 30° C.

Although FIG. 2 shows a 12-fiber ribbon, there is no intent to limit the disclosure to the embodiment to only the 12-fiber ribbon. For example, in one embodiment, an optical-fiber ribbon comprises at least two reduced-diameter optical fibers oriented in parallel with one another in a single plane, and a ribbon matrix layer formed from acrylate-based material surrounding and in direct contact with the at least two reduced-diameter optical fibers.

In that embodiment, each of the reduced-diameter optical fibers meets the ITU-T G.657.A1 standard or the ITU-T G.652.D standard, is coated with primary and secondary coatings, and has an outer diameter of less than about 205 microns. Furthermore, the ribbon matrix layer is substantially rectangular in cross section with a local ribbon thickness of more than about 270 microns. Because of the thicker ribbon matrix layer protects the reduced-diameter optical fibers inside the optical-fiber ribbon, the ribbon attenuation of the optical-fiber ribbon is less than about 0.35 dB/km at a wavelength of 1310 nanometers, and less than about 0.25 dB/km at a wavelength of 1550 nanometers.

Preferably, the local ribbon thickness is more than about 280 microns. In this specification, “local ribbon thickness” is defined as a thickness of the optical fiber ribbon where a center of the reduced-diameter optical fiber is located as indicated in FIG. 2 as T_{LR}.

In yet another embodiment, an optical-fiber ribbon is characterized by a weight ratio of the optical fibers and the optical-fiber ribbon. For example, an optical-fiber ribbon comprises a plurality of reduced-diameter optical fibers and a ribbon matrix surrounding the reduced-diameter optical fibers. In the embodiment, the weight ratio R of the reduced-diameter optical fibers and the optical-fiber ribbon is more than about 0.55. Preferably, the weight ratio R is 0.55≦R≦0.80. Most preferably, the weight ratio R is 0.60≦R≦0.70. The weight ratio R is defined as:

$$R = \frac{{W}_{f}}{{W}_{r}}$$

Where W_{f} is a weight of the reduced-diameter fibers inside the optical-fiber ribbon and Wᵣ is a total weight of the optical-fiber ribbon.

In the embodiment, each of the reduced-diameter optical fibers meets the ITU-T G.657.A1 standard or the ITU-T G.652.D standard, is coated with primary and secondary coatings, and has an outer diameter of less than about 205 microns. Furthermore, the ribbon attenuation is less than about 0.35 dB/km at a wavelength of 1310 nanometers, and less than about 0.25 dB/km at a wavelength of 1550 nanometers. Preferably, the optical-fiber ribbon is 12-fiber or 24-fiber optical-fiber ribbon. However, 4-fiber, 6-fiber, 8-fiber, 16-fiber and 36-fiber optical-fiber ribbons are also common, and within the scope of the disclosure.

In a preferred embodiment, any of the optical-fiber ribbons disclosed above is a single-layer optical-fiber ribbon. In this specification, “single-layer optical-fiber ribbon” means an optical-fiber ribbon where optical fibers are surrounded by a single layer of ribbon matrix. Applying the matrix in a single layer minimizes process labor and complexity. However, it is also possible to make ribbons in a two-pass process, especially one in which two smaller ribbons are joined together to make a larger ribbon using a second application of matrix adhesive, for example joining two 12-fiber ribbons to make a 24-fiber ribbon.

Disclosed optical-fiber ribbons can be manufactured using the following method. First, predetermined numbers of reduced-diameter optical fibers are paying out from a pay-off. Those optical fibers are feed in the same plane, parallel, into a ribbon die. Ribbon matrix, made of acrylate material, is pumped through the die and surrounds the optical fibers. The ribbon die should be designed to provide sufficient ribbon matrix around the optical fibers so that the resulting optical-fiber ribbon has desired local ribbon thickness and/or local matrix thickness about each fiber in the ribbon. As fibers surrounded by the ribbon matrix exit from the die, they immediately pass through a UV oven for curing of the ribbon matrix. Depending on the line speed of ribbon production, 2 or 3 UV ovens may be required to achieve the desired cure percentage. Once ribbon passes through the ovens, usually a printer marks it for identification purposes. The ribbon then is then taken up on a spool.

A plurality of the optical-fiber ribbons may be arranged in a rectangular shape to form a ribbon stack. Any combination of ribbon stack is possible. However, twelve stacks of 12-fiber ribbons (12×12), eighteen stacks of 24-fiber ribbons (24×18), and thirty-six stacks of 24-fiber ribbons (24×36) are common embodiments.

Furthermore, one or more optical-fiber ribbons or ribbon stacks maybe placed inside a buffer tube, and placed inside an optical-fiber ribbon cable. A typical optical-fiber ribbon cable comprises a cable jacket and one or more buffer tubes positioned within the cable jacket. The one or more of the buffer tubes may include one or more of the optical-fiber ribbons.

By using the disclosed optical-fiber ribbons, affordable compact cables that maintain similar performance as equivalent larger cables can be made. Alternatively, for the same size, more optical fibers can be placed within the cable.

Although exemplary embodiments have been shown and described, it will be clear to those of ordinary skill in the art that a number of changes, modifications, or alterations to the disclosure as described may be made. For example, although reduced-diameter optical fibers shown in embodiments are single-mode optical fibers, it should be appreciated that the disclosure is also applicable to reduced-diameter multimode optical fibers. The optical-fiber ribbon using such reduced-diameter multimode optical fibers would exhibit the ribbon attenuation of less than about 3.0 dB/km at a wavelength of 850 nanometers, and less than about 1.0 dB/km at a wavelength of 1300 nanometers. All such changes, modifications, and alterations should therefore be seen as within the scope of the disclosure.

What is claimed is:

1. An optical-fiber ribbon comprising:
a plurality of reduced-diameter optical fibers, each of the reduced-diameter optical fibers meets the ITU-T G.657.A1 standard or the ITU-T G.652.D standard, is coated with primary and secondary coatings, and has an outer diameter of less than about 205 microns; and
a ribbon matrix surrounding the reduced-diameter optical fibers,
wherein a local matrix thickness of the optical-fiber ribbon is more than about 35 microns and, the ribbon attenuation is less than about 0.35 dB/km at a wavelength of 1310 nanometers, and less than about 0.25 dB/km at a wavelength of 1550 nanometers.

2. The optical-fiber ribbon of claim 1, wherein the local matrix thickness is defined as a minimum distance between an outer surface of the reduced-diameter optical fiber and an outer surface of the optical-fiber ribbon.

3. The optical-fiber ribbon of claim 2, wherein the local matrix thickness is more than about 40 microns.

4. The optical-fiber ribbon of claim 1, wherein the ribbon attenuation is measured in accordance with the FOTP-78 standards in which the optical-fiber ribbon was measured on a ribbon spool having a hub diameter of 5.54 inches using an optical time-domain reflectometer (OTDR).

5. The optical-fiber ribbon of claim 1, wherein at least one of the reduced-diameter optical fibers is a single-mode optical fiber.

6. The optical-fiber ribbon of claim 1, wherein at least one of the reduced-diameter optical fibers is colored and has a slickness of less than about 10 g, and an outer most coating of the reduced-diameter optical fibers is substantially cured.

7. The optical-fiber ribbon of claim 6, substantially cured means that at least 87% of the coating is cured.

8. The optical-fiber ribbon of claim 1, wherein the optical-fiber ribbon is a single-layer optical-fiber ribbon.

9. The optical-fiber ribbon of claim 1, wherein the ribbon matrix has a tensile modulus of between 250 MPa and 800 MPa.

10. The optical-fiber ribbon of claim 1, wherein the ribbon matrix has a viscosity of between 3000 mPas-sec and 5000 mPas-sec at about 30° C.

11. A ribbon stack comprises one or more optical-fiber ribbons of claim 1, wherein the optical-fiber ribbons are arranged in a rectangular shape.

12. A buffer tube comprises one or more optical-fiber ribbons of claim 1, wherein the optical-fiber ribbons are arranged in a rectangular ribbon stack.

13. An optical-fiber ribbon cable, comprising:
a cable jacket; and
one or more buffer tubes positioned within the cable jacket,
wherein one or more of the buffer tubes include one or more of the optical-fiber ribbons of claim 1.

14. An optical-fiber ribbon comprising:
at least two reduced-diameter optical fibers oriented in parallel with one another in a single plane, wherein each of the reduced-diameter optical fibers meets the ITU-T G.657.A1 standard or the ITU-T G.652.D standard, is coated with primary and secondary coatings, and has an outer diameter of less than about 205 microns; and
a ribbon matrix layer formed from acrylate-based material surrounding and in direct contact with the at least two reduced-diameter optical fibers, wherein the ribbon matrix layer is substantially rectangular in cross section with a local ribbon thickness of more than about 270 microns,
wherein the ribbon attenuation is less than about 0.35 dB/km at a wavelength of 1310 nanometers, and less than about 0.25 dB/km at a wavelength of 1550 nanometers.

15. The optical-fiber ribbon of claim 14, wherein the local ribbon thickness is defined as a thickness of the optical fiber ribbon where a center of the reduced-diameter optical fiber is located.

16. The optical-fiber ribbon of claim 14, wherein the local ribbon thickness is more than about 280 microns.

17. The optical-fiber ribbon of claim 14, wherein the optical-fiber ribbon is a single-layer optical-fiber ribbon.

18. An optical-fiber ribbon comprising:
a plurality of reduced-diameter optical fibers, each of the reduced-diameter optical fibers meets the ITU-T G.657.A1 standard or the ITU-T G.652.D standard, is coated with primary and secondary coatings, and has an outer diameter of less than about 205 microns; and
a ribbon matrix surrounding the reduced-diameter optical fibers,
wherein a weight ratio R of the reduced-diameter optical fibers and the optical-fiber ribbon is more than about 0.55, and the ribbon attenuation is less than about 0.35 dB/km at a wavelength of 1310 nanometers, and less than about 0.25 dB/km at a wavelength of 1550 nanometers.

19. The optical-fiber ribbon of claim 18, wherein the weight ratio R is defined as:
$$R = \frac{{W}_{f}}{{W}_{r}}$$
Where W_{f} is a weight of the reduced-diameter fibers in the optical-fiber ribbon and Wᵣ is a weight of the optical-fiber ribbon.

20. The optical-fiber ribbon of claim 18, wherein number of reduced-diameter optical fibers in the optical-fiber ribbon is 8, 12, 16, 24, or 36

21. The optical-fiber ribbon of claim 18, wherein the weight ratio R is 0.55≦R≦0.80.

22. The optical-fiber ribbon of claim 18, wherein the weight ratio R is 0.60≦R≦0.70.

23. The optical-fiber ribbon of claim 18, wherein the optical-fiber ribbon is a single-layer optical-fiber ribbon.

24. An optical-fiber ribbon comprising:
a plurality of reduced-diameter optical fibers, each of the reduced-diameter optical fibers meets the ITU-T G.657.A1 standard or the ITU-T G.652.D standard, is coated with primary and secondary coatings, and has an outer diameter of less than about 205 microns; and
a ribbon matrix surrounding the coated optical fibers,
wherein a local matrix thickness of the optical-fiber ribbon is more than about 35 microns and, the ribbon attenuation is less than about 3.0 dB/km at a wavelength of 850 nanometers, and less than about 1.0 dB/km at a wavelength of 1300 nanometers.

25. The optical-fiber ribbon of claim 24, wherein at least one of the reduced-diameter optical fibers is a multimode optical fiber.

26. The optical-fiber ribbon of claim 24, wherein the optical-fiber ribbon is a single-layer optical-fiber ribbon.
